(19) United States
(12) Patent Application Publication
(10) Pub. No.: US 2002/0067835 A1
(43) Pub. Date: Jun. 6, 2002

(54) Method for centrally recording and modeling acoustic properties

(76) Inventor: Michael Vatter, Gleisdorf (AT)

Correspondence Address: HENRY M FEIEREISEN, 350 FIFTH AVENUE, SUITE 3220, NEW YORK, NY, 10118, US

(21) Appl. No.: 09/994,180

(22) Filed: Nov. 26, 2001

Related U.S. Application Data
(60) Provisional application No. 60/250,992, filed on Dec. 4, 2000.

(30) Foreign Application Priority Data
Dec. 4, 2000 (AT) A 2023/2000

(51) Int. Cl. H04R 29/00

(52) U.S. Cl. 381/58; 381/63; 381/59

(57) ABSTRACT

Computer-aided methods and systems are proposed for centrally recording and modeling the acoustics of a closed room or partially enclosed room, wherein a room response is measured locally with a local computer by generating a sound signal with at least one acoustic source and recording the acoustic response with at least one measuring microphone. Software is downloaded to the local computer from a remote central computer, and the measured data are transmitted for further processing from the local computer to the remote central computer, optionally together with additional data required for the additional processing. The amplification factors of the acoustic source output and the microphone input can be calibrated automatically. The methods and systems can also be used to process other physical measurements.

### CROSS-REFERENCES TO RELATED APPLICATIONS

This application claims the benefit of prior filed provisional application, Appl. No. 60/250,992, filed Dec. 4, 2000, pursuant to 35 U.S.C. 119(e), the subject matter of which is incorporated herein by reference.

This application claims the priority of Austrian Patent Application, Serial No. A 2023/2000, filed Dec. 4, 2000, the subject matter of which is incorporated herein by reference.

### BACKGROUND OF THE INVENTION

The present invention relates to a method for centrally recording and modeling the acoustics in a closed room or a partially enclosed room section outdoors. In this context, the acoustic room properties, preferably a room response, is measured locally, wherein a sound signal is excited by at least one acoustic source in the room or room section, which is recorded by one or several measuring microphones.

Methods are known for recording of the acoustics of a room and, in particular for initial measuring and testing of sound reproducing devices, wherein for measuring the room response a sound signal is produced by an acoustic source and recorded by a measuring microphone. In particular, such methods are employed with impulse sound tests which has been used for some time in room acoustics.

Measurements with this method, however, require a separate measurement device with a DSP card, a loudspeaker and a microphone. For measuring the acoustic room properties, this measurement device has to be placed on site and operated by a trained technician. This is quite expensive, in particular counting travel time for trained personnel, which slows the measurement process down and makes it more expensive.

It would therefore be desirable and advantageous to provide an improved method for centrally recording and modeling the acoustics of a closed room or a partially enclosed room section outdoors, to obviate prior art shortcomings and to provide the foundation for a decentralized measurement method which uses a measurement platform that is not based on a stand-alone principle.

### SUMMARY OF THE INVENTION

According to one aspect of the invention, the local measurement is performed using a local computer, for example a conventional personal computer, with software for the computer-aided local measurement being transmitted from a central computer to the local computer, preferably via a long distance data line. The data produced by the measurement, and optionally additional data required for processing, are transmitted for further processing to the central computer or one or several other computers. In this way, the acoustic room properties can be measured locally on location without requiring a separate measurement device.

According to one embodiment of the invention, the software and/or the data can be particularly easily transmitted at high speed via the Internet. Alternatively, software and/or the data that include large amounts of data and/or additional data, such as operating manuals, etc., can be transmitted via data carriers, in particular via compact disc.

According to another aspect of the invention, a method is proposed for measuring the acoustic room properties, in particular the room response, in an enclosed room or a partially enclosed room outside, wherein a sound signal is produced by at least one acoustic source in the room or room section and the sound signal is recorded by one or several measuring microphones. The method includes at least one calibration step for the amplification factors for the acoustic source output and for the microphone input.

Methods are known for measuring the acoustic room properties of a closed or partially enclosed room outdoors, which include at least one calibration step for the amplification factors for the acoustic source output and for the microphone input. Such methods include the use of, for example, a TEF-analyzer and a MLSSA-card.

However, calibrating at least one audio component with this method requires a trained technician.

It would therefore be desirable and advantageous to provide an improved method for measuring the acoustic room properties, which obviates the aforedescribed disadvantages and makes it possible to perform the measurement in a simple manner, in particular by using untrained workers.

This is achieved by the invention in that the amplification factors of the acoustic source output and the microphone input are calibrated automatically, which obviates the need for a user to perform a separate calibration step.

According to one embodiment, the amplification factors of the acoustic source output and the microphone input can be determined by an automatic calibration process, wherein pulses of a test signal are transmitted to the acoustic sources and the signal reproduced by the acoustic sources is sensed by the measuring microphone. The amplification factors of the acoustic sources and the measuring microphone are adjusted until, on one hand, a predetermined difference in level is achieved between the recorded test signal and the recorded intrinsic noise level and, on the other hand, no saturation is observed during sensing.

According to another embodiment of the invention, to ensure an adequate signal-to-noise ratio, the level difference between the recorded test signal and the recorded intrinsic noise level is at least 30 dB.

According to yet another embodiment of the invention, the duration of the local measurement can be optimized by transmitting a measurement signal to the acoustic sources and simultaneously recording the signal of the measuring microphone. The duration of the recording is hereby extended beyond the termination of the measurement signal until a predetermined level difference is obtained between the measured signal and the level measured during the transmission of the measurement signal.

According to another embodiment of the invention, an optimal broadband frequency response for signal processing can be obtained by using a measurement signal composed preferably of white noise or pink noise. The measurement duration can be reduced further by using a measurement signal comprised of a pseudorandom noise signal produced by the MLS method.

According to another embodiment of the invention, the room response to different sound signals can be measured by using a measurement signal that has two segments, wherein the first segment is composed of a pseudorandom noise signal produced by the MLS method, and the other segment is preferably composed of white noise or pink noise.

The invention is also directed to a computer system capable of executing a computer program for measuring the acoustic room properties, with the computer program causing the computer system to perform the method of the invention described above.

The invention is also directed to a computer program product for measuring the acoustic room properties, preferably the room response, in a closed room or a partially enclosed room section outdoors, wherein the program product can be loaded directly into memory of a digital computer. The computer program product running on a computer includes software code segments adapted to operate according to the method described above.

The invention is also directed to a computer program product for measuring the acoustic room properties, preferably the room response, in an enclosed room or a partially enclosed room section outdoors, wherein the computer program product is stored on computer-related media. The computer program product running on a computer includes computer-readable program means that cause a computer to perform the aforedescribed method.

The invention also relates to a method for recording and processing data that require the local measurement of one or several physical quantities.

Measurements of certain physical quantities can frequently only be performed at a customer site when trained technicians are available.

It would therefore be desirable and advantageous to provide an improved method for recording and processing data, wherein one or several physical quantities have to be measured locally and wherein the measurement can be performed locally by untrained workers, with the processing being done at a central location.

According to another aspect of the invention, the local measurement is performed with a local computer, for example a conventional personal computer, and the software for the computer-aided local measurement is transmitted from a central computer to a local computer, preferably via long distance lines. The data derived from the measurement are returned, optionally with additional data required for processing, to the central computer or to another computer or several other computers.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1 is a schematic diagram of an arrangement for measuring the acoustic room properties;

FIG. 2 is a schematic diagram of another arrangement for measuring the acoustic room properties with an amplifier and a mixing console;

FIG. 3 is a flow diagram depicting a method for automatic calibration of the amplification factors;

FIG. 4 is another flow diagram of a method for determining optimal amplification factors;

FIG. 5 is a typical signal path during automatic calibration;

FIG. 6 is a typical signal path during a measurement; and

FIG. 7 is a flow diagram that depicts using the method of the invention in an e-commerce application.

### DETAILED DESCRIPTION OF PREFERRED EMBODIMENTS

The method according to invention can be applied to evaluate and/or improve the acoustics in an enclosed room or in a partially enclosed room outdoors, for example an open-air theater, sports facilities and the like. The acoustic properties of the respective room have to be measured in order to determine the acoustic response. In general, the acoustics of a room is evaluated by measuring the sound reflection in the room; however, other measurements, such as an impulse response of the room, can also be used. An impulse sound test can indicate in which order and from which direction sound and reflected sound arrive at a certain location. A number of other measurements, such as measures of the clarity, the reverberation, reflections, etc., can be derived from the test results. Data such as the room geometry and the materials associated with individual surfaces can, of course, also help in the understanding of the geometric room acoustics, since the primary reflections can be described adequately by taking into account the geometry and the laws of reflection. However, the more closely spaced sequence of reflections responsible for reverberations require statistical analysis for calculating the reverberation time. After from the primary reflections, the reverberation time is of great significance when evaluating acoustic properties, and is a global criteria for the acoustic properties of room in the field of statistic room acoustics. The obtained data can also be used for wave-theory-based calculations of the room acoustics, for example, for investigating the acoustic response of small rooms with little damping.

Measurements of the aforedescribed type are intended for sound stages, movie theaters and concert halls, show stages, seminar and conference rooms, school class rooms and auditoriums. All these places require an optimally tuned room acoustics for good speech and music reproduction. The measurement can form the basis for the installation of additional acoustic absorption and diffusion elements to optimize the room acoustics for the planned use.

Until now, such measurements required a dedicated and separate measurement device with a DSP card, a loudspeaker and a microphone and/or a stand-alone device. When measuring the acoustic room properties, the measurement device had to be positioned on site and operated by a trained technician. This resulted in high personnel cost, in particular due to travel times, which increased the cost of the measurement.

Conversely, according to the method presented in the present application, the acoustic response is recorded and/or modeled by performing the measurements locally using a local computer, such as a conventional personal computer (PC) 1, wherein software for the computer-supported local measurement is transmitted from a central computer to the local computer, preferably via a long distance line. The data obtained from the measurement, optionally together with other data required for processing the measured data, are transmitted for further processing to the central computer or to one or several additional computers. This method only requires a conventional PC 1 with a sound card, at least one loudspeaker 2 representing the acoustic source, and at least one microphone 3 that present in most sound studios. In the context of this application, the term “PC” is not limited to the customary personal computer with a processor, monitor, keyboard and mouse, but can include other forms, such as laptops or personal digital assistants (PDA), as long as these devices have adequate computer power, other simple terminals, which need not include a hard disk, but also other powerful computer referred to as servers. Because these computer categories are difficult to differentiate, the term PC is applied to all these embodiments. The computer may also be implemented in different hardware, for example as microprocessor-controlled sound equipment.

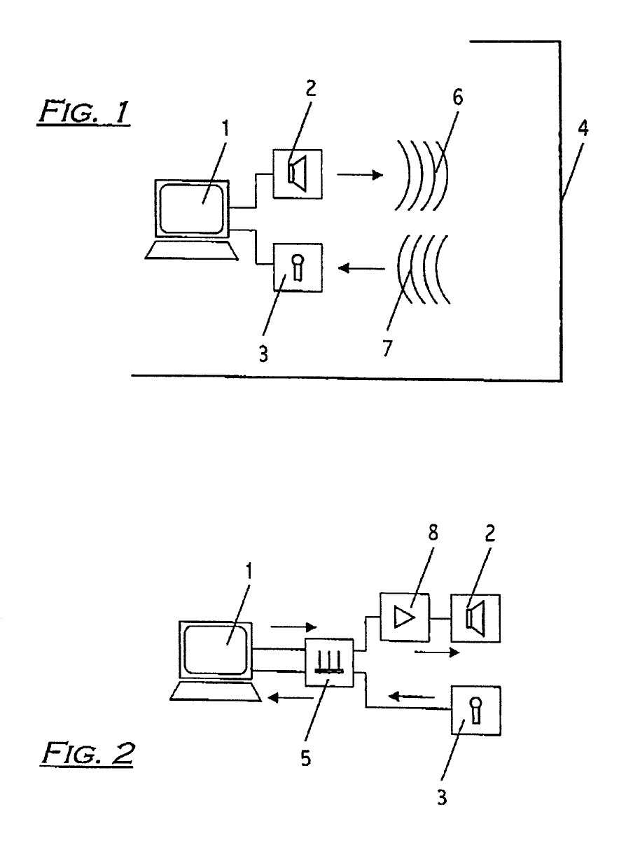

Referring now to FIG. 1, the acoustic room properties, preferably the room response, is measured by radiating in a room 4 a sound signal 6 from a loudspeaker 2. The sound signal is recorded by one or several measuring microphones 3. The measurement itself does not require special knowledge and can be executed on site by untrained personnel. The loudspeaker 2 can be the internal loudspeaker of the PC 1 itself or external loudspeakers 2. The microphone 3 can also be formed by the computer microphone found integrated with conventional computers. Advantageously, the response of the microphone 3 need not be linear, since only the die-away (decay) time is measured.

Turning now to FIG. 2, the PC 1 can be connected to the microphone 3, the amplifier 8 and the loudspeaker 2 via a mixing console 5, or directly to the loudspeaker 2. The PC 1 can also be connected to external sound reproduction devices as long as the external devices are controlled by the computer.

In general, the measuring microphone should be located in the room 4 essentially in the listening position, meaning in a position from which a sound technician monitors the reproduction of a particular audio recording via the loudspeaker. When larger areas are to be measured, such as rows of seats in a movie theater, the microphone 3 can be placed at several different measurement positions, or several microphones 3 can be employed. In particular, the position of the measuring microphone 3 may be varied to prevent distortion of the results due to standing waves in the room 4. Advantageously, the microphone 3 can also be placed at a location other than the listening position. For example, low frequencies can be measured more reliably near the room boundaries. The locations of the measuring microphones 3 and the acoustic sources 2 in the room 4 represent a portion of the geometric room data that are required for additional processing of the measurement results. The room geometry, in particular the surface area, and optionally the materials associated with individual surfaces of the room 4, are also part of the room data.

The method presented in this application forms the basis for a decentralized measurement method. A measurement platform is provided that is not based on a stand-alone principle, but enables the measurement of acoustic room parameters with a distributed system, such as a PC-based sound card and software. The measurement can be easily performed by a user. Only a PC 1 with sound card, and a suitable loudspeaker 2 and a microphone 3, are required for measuring the data that describe the acoustic room properties of the room 4 and/or the room section. Suitable hardware is, for example, a PC with a sound card with 16-bit resolution, line out, line in or a microphone input, a suitable microphone for the measurement, an amplifier, a loudspeaker, and optionally a mixing console. The software can be designed for a particular operating system, such as Microsoft Windows® or Mac OS®) or for an operating-system-independent compiler language, such as Java® or script languages, such as Perl, or other command-driven interpreter languages. The program can also be transmitted as source code or object code, in a high-level language or in machine language.

The software is required for measuring the data used for the analysis. The software is transferred via a data connection to the PC 1. This can be accomplished via email or via a transfer protocol, such as NFS, FTP, HTTP and the like. Details of the transmission protocol and encoding of the program data are not important. However, it is essential that the software necessary for the measurement is transmitted to the local PC 1. The can be accomplished in a conventional manner, for example via a CD or another data carrier. In another advantageous embodiment of the invention, the software and/or the data are transmitted via a data carrier. A wireless transmission is also feasible. Essential for all forms of transmission is that the software for performing the measurement is transmitted to the PC located in the measurement area and is initiated on the PC. A CD can be implemented, for example, in form of a multimedia CD that holds not only the measurement software, but also additional data, such as operating manuals, technical documentation and information as well as advertising material that may suggest ways to optimize the acoustic diffusion and absorption elements. Alternatively, the software can be offered on the company's homepage for downloading. The download homepage is then the actual interface with the user. After the user has obtained information about a product and becomes interested in the project, he can then download the software package to his computer. Advantageously, the software and/or the data can also be transmitted via the Internet, in which case a user interface can be easily implemented. Moreover, the software can be supplied for free, since delivery costs are eliminated. In this way, the simplest and fastest transmission is achieved.

After the measurement program has been transmitted to the local PC 1, the user starts the measurement program and connects the loudspeaker system 2 and a microphone 3. The master data should also be supplied at this time, which include personal data as well as the dimensions and characteristics of existing room surfaces. Alternatively, the master data can be supplied at a later time.

With the aforedescribed method and software, the amplification factors of the acoustic source output 2 and the microphone input 3 can be calibrated automatically. The loudspeakers 2 can be calibrated individually or together. In the calibration process, continuous pulses of a test signal are transmitted via the output to the amplifier 8 and then to the loudspeakers 2. In a preferred embodiment of the invention, the test signal pulses are transmitted to the acoustic sources, the signal reproduced by the acoustic sources is sensed by the measuring microphone 3 and the amplification factors for the acoustic sources and the loudspeakers 2, respectively, and the measuring microphone 3 are adjusted until, on one hand, a predetermined level difference between the recorded test signal and the recorded intrinsic noise level is achieved and, on the other hand, no saturation is observed during sensing.

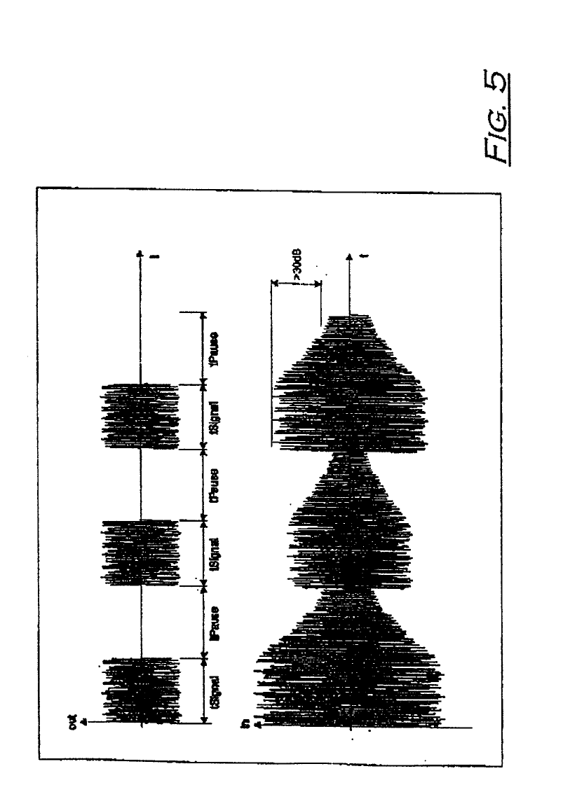

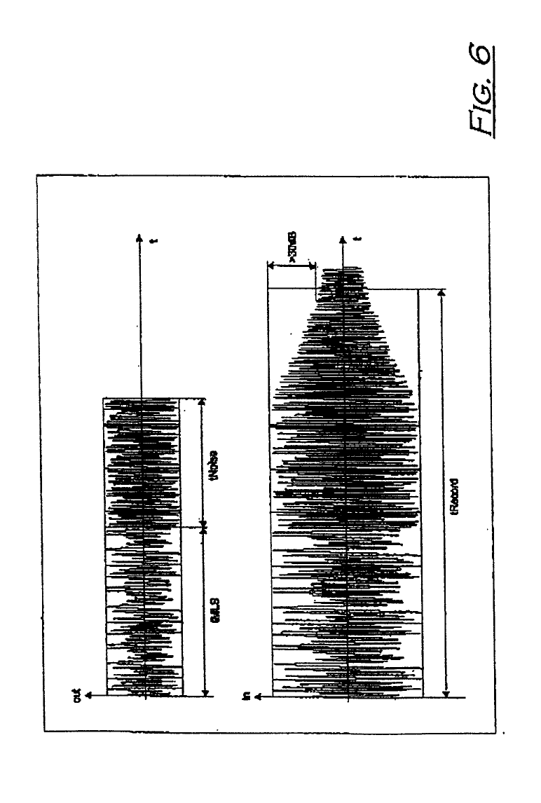

Referring now to FIG. 5, the test signal which can consist of, for example, white noise, typically has a certain signal amplitude “iSignal” and a certain signal duration “tSignal”. The noise is sent to the loudspeakers 2 and recorded by the microphone 3. Additional possible forms of the test signal are, for example, a sweep sinusoidal waveform or a multi-sinusoidal waveform. The room response can be determined in particular by using a multi-sinusoidal waveform. After the test signal is transmitted, no signal is transmitted for a duration “tPause”. The signal reproduced by the loudspeakers 2 is recorded by the measuring microphone 3 and transmitted via the mixing console 5 to the line input of the sound card where it is sensed (see FIG. 2). The level difference between the recorded test signal and the recorded intrinsic noise level should be at least 30 dB. The amplification of the line input and the line output can be changed until, on one hand, a level difference of more than 30 dB between the recorded test signal and the recorded intrinsic noise level is observed during the signal pauses and, on the other hand, no saturation occurs during sensing. The required level difference may be selected to be smaller or greater than 30 dB. However, a value of 30 dB has been found to be particularly suitable. It is possible to use other methods to calibrate the microphone 3 and the loudspeakers 2.

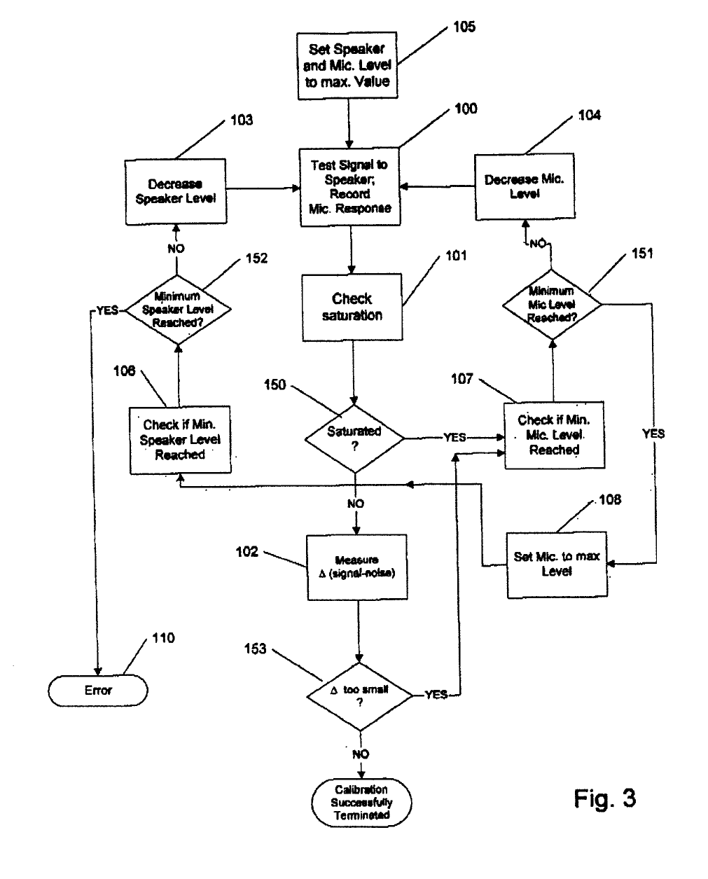

In the schematic flow diagram depicted in FIG. 3, the amplification factors for the loudspeakers 2 and the microphone 3 are first set to their maximum value, step 105. The test signal is then supplied to the loudspeakers 2 and the room response is recorded by the microphone 3, step 100. The recorded signal is then checked for saturation effects, step 101. If saturation is observed, step 150, then it is checked in step 107 if the minimum level of the microphone has been reached. If the minimum level of the microphone has not been reached, as checked in step 151, then the level for the microphone 3 is decreased, step 104, and the process is repeated until the signal is no longer saturated or the minimum signal level of the microphone 3 is reached. If on the other hand the minimum level of the microphone has been reached, as determined in step 151, then the level for the microphone 3 is initially set to the maximum value, step 108, and it is checked in step 106 if the minimum level of the loudspeakers has been reached. If the minimum level of the loudspeakers has not been reached, as determined in step 152, then the level of the loudspeaker 2 is decreased, step 103, and the measurement process is repeated until the signal is no longer saturated or the minimum level of the loudspeaker 2 is reached. If on the other hand the minimum level of the loudspeaker has been reached, as determined in step 152, meaning that no adequate signal can be obtained, then the calibration is canceled and an error message may be sent, step 110. If a signal can be obtained without saturation as determined in step 150, then the level difference between the signal and the background noise is evaluated, step 102. If the difference in levels is too small, as determined in step 153, then the measurement is repeated, starting with step 107, until the difference is sufficiently large. Otherwise, the calibration is successfully terminated following step 153.

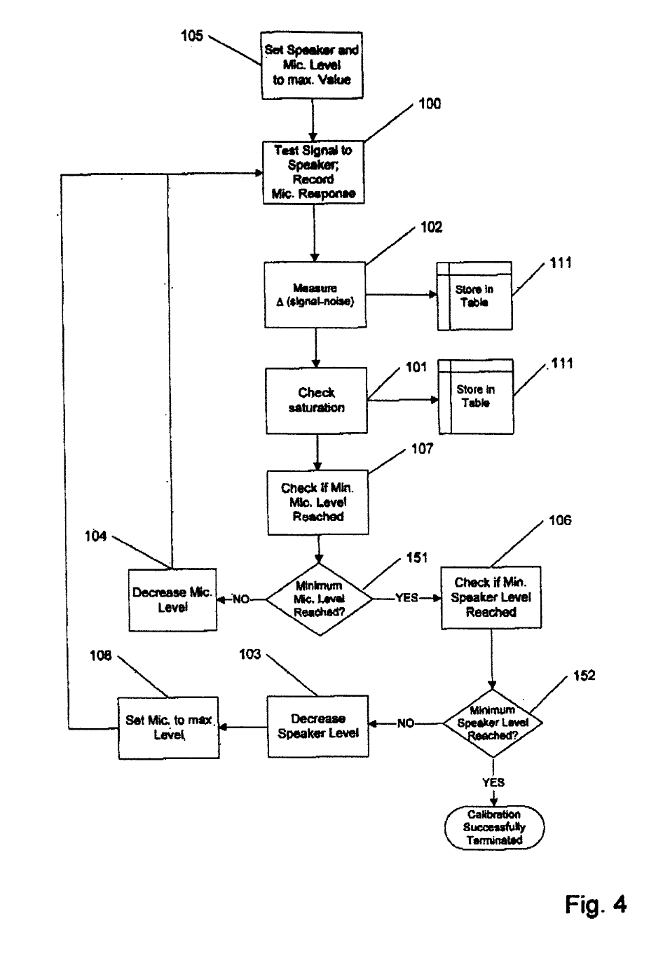

Another method for automatic calibration is depicted in FIG. 4. Like in the embodiment previously described with reference to FIG. 3, the amplification factors for the loudspeakers 2 and the microphone 3 are set to the maximum value, step 105. Subsequently, all amplification factors are executed in two nested loops (steps 100-151, 104,100) and (steps 100-151, 106-108, 100). In the first loop (steps 100-151, 104, 100), a test signal is supplied to the loudspeakers 2 and the room response is recorded by the microphone 3, step 100. The level difference between the signal and the background noise is evaluated in step 102 and the current values for the level difference is stored in a table, step 111. Likewise, the signal is checked for saturation effects, step 101, and a current value representing the signal quality, such as degree of saturation, is stored in a table, step 111. The table can be structured in a manner known in the art. It is then checked in step 107 if the microphone level has reached a minimum value. If the microphone level has not reached a minimum value, as determined in step 151, the microphone level is decreased, step 104, and the process returns to step 100. The second loop (steps 100-151, 106-108, 100) is executed after it is determined in step 151 of the first loop that the microphone level has reached a minimum value. In the second loop, step 106 checks if the minimum loudspeaker level is reached. If the minimum level of the loudspeakers has not been reached, as determined in step 152, then the level of the loudspeaker 2 is decreased, step 103, the microphone level is set to its maximum level, step 108, and the measurement process is repeated by returning to step 100. If the minimum level of the loudspeakers is reached, as determined in step 152, then the calibration is successfully terminated following step 152. The optimum combination for the amplification factors is determined from the table after the loop has successfully terminated. As mentioned above, the amplification factors and the associated signal quality and signal-to-noise ratio can be stored in a simple table structure.

In addition, user himself may be allowed to make additional manual corrections to the calibration, without substituting these manual corrections for the automatic calibration which is the basic concept of the invention. As an essential feature of the invention, the calibration is performed automatically, includes software and requires, on one hand, that a certain minimum level difference between the test signal and the basic noise level exists and, on the other hand, that the measurement signal does not saturate during sensing.

For example, a signal can be supplied to indicate when the level is properly adjusted. Thereafter, the actual measurement process is started and the reverberation time is automatically measured. During the actual measurement process, a noise signal is sent to the loudspeaker 2 and recorded by the microphone 3. As indicated in FIG. 6, a special measurement signal is transmitted to the loudspeakers 2 and the signal radiated by the loudspeakers is recorded by the measuring microphone 3. In a preferred embodiment of a local measurement performed with the illustrated method, a measurement signal is transmitted to the acoustic sources and the signal derived from the measuring microphone is simultaneously recorded. The recording is thereby extended beyond the termination of the measurement signal until a predetermined level difference is obtained between the measured signal and the level measured during the transmission of the measurement signal. This level difference depicted in FIG. 6 is again 30 dB; however, a different value can also be selected. The measurement signal in FIG. 6 is composed of two segments, a first segment consisting of a pseudorandom noise signal that is generated by the maximum length sequence (MLS) method and a second segment preferably consisting of white or pink noise. Additional measurement signals can also be used. Optionally, other methods can be employed wherein a selection can be made between noise and an MLS signal. The noise signal and/or the MLS signal can be generated by the computer using a program or from a data file, for example in .wav format file.

Advantageously, the measurement time can be further reduced by using the MLS method. It is known that useful signals and a noise signals can be eliminated during an impulse sound test or a test with a similar method by using identical impulse signals to stimulate the audio signal in the room to be measured. In this way, the useful signal which is always the same can be separated from the noise signal which will always be different. The resulting longer measurement time can be avoided with the MLS method. Binary MLS signals are periodic bi-level pseudorandom sequences of a length L=2^{N}−1, wherein N is an integer. All other measurement values can be derived from the cross-correlation between the system response to the signal and the original sequence.

Other measurements, besides measurements of the pure reverberation time, can also be performed, such as measurement of the frequency and phase dependence of the sound pressure level in the diffuse sound field. For measuring the room impulse response, sound reflections and reverberation are generated by a short sound pulse, for example a bang. In this case, the short pulse duration makes it possible to measure the reflections without superposition of the subsequently arriving direct sound. The impulse duration can be selected to be short enough so that the impulse spectrum includes the entire audible frequency range. Important conclusions about the acoustics of the research location in the room can be drawn from the reflectogram. The measurement results obtained in this way can be processed in several ways. For example, the associated room sound signal, i.e., the room simulation, can be computed by convoluting a digitally recorded room impulse response with the signal of a real sound event. Again, it is an essential feature of this method that the measurement is evaluated at a central location.

After the user has performed a valid measurement, a message is received on the PC 1 and the result can be moved to a folder. In this way, several measurements of the same room 4 can be combined in one project. For processing, the measured in data, optionally together with a geometric room data such as the location of the acoustic sources and the measuring microphone in the room, the geometry of the room area, and the type of materials associated with the individual surfaces, can be transmitted to the central server. This can be done in several ways, for example, directly from a program via a “Send” button. In general, the data are first recorded locally and thereafter transmitted to the server in an additional step. Different protocols can be used for transmitting the software to the PC 1. For example, the measurement result files can advantageously be returned to the central server via email as an entire project by clicking the “Send” button. The data may also be transmitted via CD or diskette. These data only contain the recorded measurement data. In this context, data refers to any information describing the measurement, i.e., non-digital recordings as well as measurement results that have been processed, for example, compressed, and/or into other formats converted, such as .zip or .wav file formats. However, the aforedescribed conversion of the measurement data does not to represent processing according to the invention. For processing, particular for real modeling or modeling performed with computer programs and/or for optimizing the acoustics, the data are transmitted to a central location, preferably via a long distance line. The data can also be processed at several different locations. Based on the data about the room geometry and the recorded signal, the reverberation time and the resulting options for improving the acoustics that can be achieved by using acoustically effective elements, are computed. A frequency-dependent evaluation is particularly advantageous, because conclusions can be drawn about the room response by measuring the reverberation time as a function of the frequency. For example, the result files are received by the central server and are thereafter loaded into an automatic evaluation program. A consultant can open a new project and process the room data and user data. The calculation will show, for example, a need for changes in the absorptive and/or diffusive surfaces. For example, the need for placing additional absorption elements or diffusion elements can be calculated based on the measured reverberation time and the room geometry and position of the microphones 3.

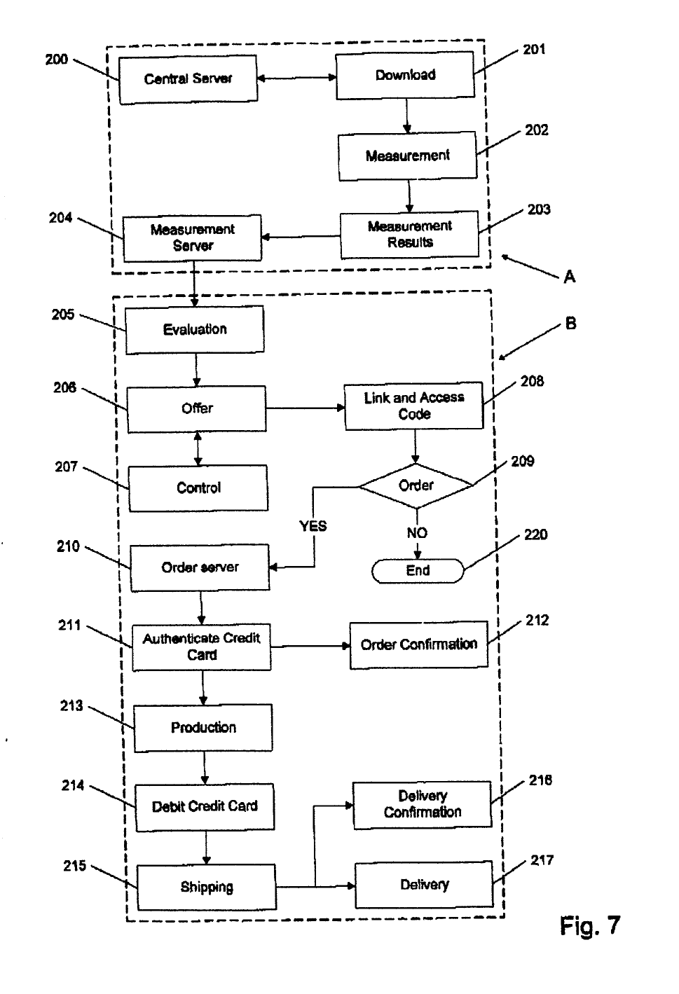

By evaluating the measurement data at a central location, the users can also be alerted to particular products. The Internet with its almost unlimited operating radius facilitates individual consultations with a minimal expenses for personnel. The aforedescribed invention can therefore advantageously be embedded in an e-commerce solution, as depicted in FIG. 7. As described above, the user records an acoustic response or another physical property (block A) by accessing a central server, step 200, to download software to the local computer, step 201. The user then starts the measurement program that now resides on the local computer, step 202, and performs the measurement, such as measuring an acoustic response or a physical quantity, step 203. The local computer then sends the measurement data and optionally other data required for processing to the central computer/server, step 204.

The process then initiates the e-commerce solution (block B). The measurements are evaluated and possible improvements of the acoustic and/or physical properties are computed by incorporating acoustically and/or physically effective elements, step 205. An offer for suitable supplies can be sent out, step 206, in several variations which can be controlled by an operator and, if necessary, corrected, step 207. The offer can be returned to the user via email, or the user can receive an message with an access code, step 208, for later access to his/her personalized offer. The user can order directly using the offer form, step 209. After confirming the individual items on the order form and entering credit card data, the user can return the order via email to the central location, step 210, or enter the order on a secure homepage. After the credit card is authenticated, step 211, the user receives an official order confirmation, step 212 with delivery details, etc. When the order is received from manufacturing or from a warehouse, step 313, the credit card is debited, step 214. The user then receives a confirmation, step 216, with an estimated delivery date/time. The parts are then shipped, steps 215, 217.

The aforedescribed method for locally measuring physical quantities can be applied to a number of other areas and experiments, where a physical measurement is required and performed by software on a conventional PC. For example, conventional digital cameras can be used to perform optical measurements. Optical signals emitted from a display screen can be measured by the digital camera. These measurements can then be evaluated, for example, at a central location and the results can be used to suggest implementation of other optical components, such as filters, to improve the performance. Likewise, other physical measurements, such as determining the speed of modem connections or a general analysis of network traffic, can also be performed with the locally transmitted software and used to suggest improvements in the network infrastructure. It is an essential feature of the aforedescribed method that the local measurement is performed with a local computer, for example, a conventional personal computer, and that software for the computer-supported local measurement is transmitted from a central computer to a local computer, preferably via a long distance data line. It is also an essential feature that the data generated by the measurement are transmitted, optionally with additional data that are required for processing, for further processing to the central computed or to another or several other computers.

While the invention has been illustrated and described as embodied in a method for centrally recording and modeling acoustic properties, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A method for centrally recording and modeling the acoustics in a closed room or a partially enclosed outdoor room section, comprising the steps of:
generating a sound signal with at least one acoustic source in the room or the room section;
recording a room response with at least one measuring microphone;
transferring software for performing a measurement of the room response from a remote central computer to a local computer to be used for the measurement;
measuring with the local computer data characteristic of the room response; and
transmitting the measured data for additional processing to the remote central computer or to at least one additional computer.

2. The method of claim 1, wherein the local computer is selected from the group consisting of personal computer, personal digital assistant, microprocessor and server.

3. The method of claim 1, wherein the measured data are transmitted together with additional data required for the additional processing.

4. The method of claim 1, wherein at least one of the software and the data are transferred via the Internet.

5. The method of claim 1, wherein at least one of the software and data are transferred via data carriers.

6. The method of claim 5, wherein the data carrier is a compact disc.

7. A method for measuring acoustic room properties of an enclosed room or a partially enclosed room, comprising the steps of:
generating a sound signal in the room or room section with at least one acoustic source;
recording the generated sound signal with at least one measuring microphone; and
calibrating an amplification factor of an output of the acoustic source and an amplification factor of an input of the microphone;
wherein the amplification factor of the acoustic source output and the microphone input are calibrated automatically.

8. The method of claim 7, wherein the automatic calibration includes transmitting a pulsed test signal to the at least one acoustic source, sensing a signal generated by the acoustic sources in response to the pulsed test signal with the measuring microphone, and adjusting the amplification factors of the acoustic sources and the measuring microphone until a predetermined level difference is obtained between the sensed signal and a recorded intrinsic noise level, without the sensed signal being saturated.

9. The method of claim 8, wherein the level difference between the sensed test signal and the recorded intrinsic noise level is that least 30 dB.

10. The method of claim 7, wherein for a local measurement, a measurement signal is transmitted to the acoustic sources to generate the sound signal, the signal obtained from the measuring microphone is recorded simultaneously with the transmission of the measurement signal, and the recording is extended past the termination of the measurement signal until a predetermined level difference between the signal obtained from the measuring microphone and a level measured during the transmission of the measurement signal is obtained.

11. The method of claim 10, wherein the measurement signal is composed of white noise or pink noise.

12. The method of claim 10, wherein the measurement signal is composed of a pseudorandom noise signal produced with the MLS method.

13. The method of claim 10, wherein the measurement signal is composed of two segments, with a first segment including a pseudorandom noise signal produced by the MLS method and the second segment composed of white noise or pink noise.

14. A computer system for measuring acoustic room properties of an enclosed room or a partially enclosed room, comprising: at least one acoustic source generating a sound signal in the room or room section;
at least one measuring microphone recording the generated sound signal; and
calibration means for automatically calibrating an amplification factor of an output of the acoustic source and an amplification factor of an input of the microphone.

15. A computer program product for measuring acoustic room properties of an enclosed room or a partially enclosed room, said program comprising software code that causes a computer to generate a sound signal in the room or room section with at least one acoustic source, record the generated sound signal with at least one measuring microphone, and calibrate an amplification factor of an output of the acoustic source and an amplification factor of an input of the microphone, wherein the amplification factor of the acoustic source output and the microphone input are calibrated automatically.

16. A computer program product embodied on a computer-readable medium for measuring acoustic room properties of an enclosed room or a partially enclosed room, the computer program product comprising computer-readable program means that enable a computer to generate a sound signal in the room or room section with at least one acoustic source, record the generated sound signal with at least one measuring microphone, and calibrate an amplification factor of an output of the acoustic source and an amplification factor of an input of the microphone, wherein the amplification factor of the acoustic source output and the microphone input are calibrated automatically.

17. A method for recording and processing data, said data representing a local measurement of one or several physical quantities, the method comprising the steps of:
performing the local measurement with a local computer;
transmitting software for performing the local measurement from a remote central computer to the local computer; and
transmitting the data obtained by the measurement for additional processing to the remote central computer or to at least one additional computer.

18. A method for engaging a user to perform a business transaction based on data representing a local measurement of one or several physical quantities, the method comprising the steps of:
transmitting software from a remote central computer to a local computer for performing a local measurement;
performing the local measurement with the local computer; transmitting the data obtained by the measurement for additional processing
to the remote central computer or to at least one additional computer; comparing the additionally processed data with expected data;
computing improved processed data by simulating the local measurement with added improvement means; and
suggesting to the user to acquire the added improvement means that cause the improved processed data to most closely match the expected data.

19. The method of claim 18, wherein acquiring the improvement means includes purchasing the improvement means.

20. The method of claim 19, further comprising debiting an account for a purchase price of the improvement means.

21. The method of claim 20, wherein the account is a credit card account, and the method further including authenticating the credit card account before the account is debited.

22. The method of claim 18, further including transmitting to the user a shipping advice of the improvement means.

23. The method of claim 18, wherein the physical quantity is an acoustic response of a room.

24. The method of claim 23, wherein the improvement means are selected from the group consisting of sound-absorbing, sound-reflecting and sound-directing elements.
